(19) United States
(12) Patent Application Publication
(10) Pub. No.: US 2009/0027549 A1
(43) Pub. Date: Jan. 29, 2009

(54) Method for processing motion pictures at high frame rates with improved temporal and spatial resolution, resulting in improved audience perception of dimensionality in 2-D and 3-D presentation

(76) Inventor: Robert C. Weisgerber, New York, NY (US)

Correspondence Address: David Peter Alan, Esq., 81 Second St., South Orange, NJ, 07079, US

(21) Appl. No.: 12/218,778

(22) Filed: Jul. 18, 2008

Related U.S. Application Data
(63) Continuation-in-part of application No. 11/478,940, filed on Jun. 30, 2006.
Application No. 11/478,940 is a continuation-in-part of application No. 10/846,611, filed on May 17, 2004, now abandoned.

(51) Int. Cl. H04N 7/01

(52) U.S. Cl. 348/441; 348/E07.003

(57) ABSTRACT

Previously-produced motion picture films are enhanced for theatrical exhibition, at double the frame rate at which they were originally produced. New images are interpolated between each of the images of the original film. These interpolated images are generated through the use of computer software that analyzes the actual horizontal and vertical displacement of each pixel of every image of the original motion picture, so the interpolated images accurately depict the exact image that would have been captured, if the original motion picture had been produced at double the actual frame rate of production. This enhancement technique can be used selectively for certain scenes or sequences of a motion picture, and not for others. Film or digital projection is suitable. Two-dimensional or three-dimensional motion pictures can be enhanced according to the method described, and motion pictures photographed at high frame rates can be converted to conventional frame rates for general release.

This application is a continuation-in part of application Ser. No. 11/478,940, filed Jun. 30, 2006, which is itself a continuation-in-part of application Ser. No. 10/846,611, filed May 17, 2004.

### FIELD OF THE INVENTION

This invention relates to the enhancement of previously-produced motion pictures for exhibition to audiences in motion picture theaters, with upgraded quality of presentation, compared to that obtainable from the motion pictures as originally produced. The invention is compatible with various current film exhibition methods, as well as the new digital motion picture exhibition.

### BACKGROUND OF THE INVENTION

There have been many recent technical advances in motion picture production and exhibition. Many have as their primary object to improve the clarity and transparency of a motion picture, as perceived by the viewers when they watch that motion picture in a theatrical setting. Improved resolution and new aspect ratios were other important objectives. The invention described here brings an improved motion picture presentation in both two-dimensional (2-D) and the three-dimensional (3-D) modes. The invention begins with reprocessing motion picture films for exhibition at a higher rate of image presentation than that used in conventional theatrical motion picture exhibition. Specifically, in the preferred embodiment, motion pictures photographed at twenty-four frames per second are enhanced for exhibition at forty-eight frames per second for film projection, or forty-eight images per second for digital presentation. Other frame rates, such as twenty-six, thirty or sixty frames per second, have also been used commercially for image capture and are compatible with the practice of this invention.

The invention described here serves as a universal processing method that prepares motion pictures for exhibition in any one of a number of uniquely highly-realistic exhibition formats. It can be used compatibly with film formats of any size, including five-perforation 70 mm or larger. It delivers a level of spatial and temporal resolution, along with significant clarity of image display, typically associated with a high-impact presentation. In addition, the digital processing administered to a motion picture in accordance with this invention also allows for digital projection with enhanced clarity and resolution, above the native resolution level of the projection system.

Beyond the above-mentioned two-dimensional film and digital applications, the invention also improves the spatial and temporal resolution of three-dimensional motion pictures through suppression of artifacts that previously plagued 3-D presentation.

While it is envisioned that the method described here will normally be used to enhance motion pictures photographed at a capture rate of twenty-four frames per second for high-impact exhibition at a higher frame rate, the method can also be used in reverse to convert original motion pictures photographed at forty-eight frames per second (or another frame rate higher than twenty-four frames per second) to the conventional exhibition rate. For this purpose, the invention can replicate the actual look of the motion picture as it would have appeared if originally photographed at a conventional frame rate, such as twenty-four frames per second. Motion pictures processed in that manner would appear as if they were actually photographed according to conventional cinematic art, thus making such motion pictures available for general release in standard motion picture theaters or for conventional video home entertainment.

Most motion picture films produced for conventional theatrical exhibition are photographed at the speed of twenty-four frames per second, a frame rate that has been in use for most of the history of cinema. At that frame rate, there exist undesirable artifacts that detract from the clarity that is a goal of modern motion picture production. Films shot at that rate have flicker, perceptible grain, and an appearance of motion that does not seem smooth. This latter artifact is particularly objectionable on large theater screens (fifty feet or more in width), since any image component must move a greater physical distance between discrete images on a large screen than on a smaller screen.

Films shot at higher frame rates succeeded, to some extent, in suppressing this undesirable artifact. Cinerama (three synchronized filmstrips photographed and projected at twenty-six frames per second, primarily used for travelogues) was somewhat successful in reducing flicker. The original Todd-AO system utilized actual photography at thirty frames per second, in addition to the conventional twenty-four frames per second. A few motion pictures, including Oklahoma and Around the World in Eighty Days, were produced in that format. However, the use of separate photography at two different frame rates was costly, and few films were produced in the Todd-AO format. More recently, the inventor herein taught a means for transitioning between film sequences photographed for exhibition at twenty-four frames per second and other sequences photographed at thirty frames per second between scenes of a single motion picture (U.S. Pat. No. 5,096,286 (1992)). While there was a perceptible improvement in smoothness of motion at the higher frame rate, the system taught in Weisgerber 286 was never developed commercially.

More recently, Weisgerber has taught the use of forty-eight frames per second as a rate for photographing and showing motion pictures, to develop a presentation that suppresses the undesirable artifacts present at twenty-four frames per second (U.S. Pat. No. 5,627,614 (1997)). In that invention, certain sequences or certain image components were photographed at forty-eight frames per second, for a “high-impact” presentation. Other sequences or image components were photographed at twenty-four frames per second and double-frame printed, to retain the artifacts that gave the film the “legacy” look. With the entire motion picture produced according to that invention projected at forty-eight frames per second, it became possible to give certain portions of a motion picture film or certain image components a more realistic look than other portions of the film or other image components. In order to deliver the full impact to the audience, the preferred embodiment of that invention used a large format, such as 70 mm theatrical format, equivalent to eight perforations high. The images had been squeezed anamorphically onto the conventional 70 mm (five-perforation) format for storage on the film reel and stretched to the eight-perforation aspect ratio upon projection in the theater.

The previously-mentioned invention only works optimally for films produced according to it. This means that it could only deliver the full audience effect in new films. For films already in existence, the full effect can only be delivered if those films are enhanced and converted for projection at a frame rate of forty-eight frames per second or higher. Most commercially produced films, including IMAX films, are photographed at twenty-four frames per second. Today, most commercial films are photographed in the 35 mm feature film format with four, or sometimes three, perforations per frame. That format does not allow for sufficient visual information storage to deliver the full effect of the previous Weisgerber invention, which requires the 70 mm film format to deliver the full desired effect. With the invention described here, films produced in the 35 mm format can be converted to the 70 mm format for the desired high-impact presentation, comparable to contemporary production standards. Most importantly, twenty-four discrete images each second are not enough to provide for the smooth appearance of motion delivered by the previous Weisgerber invention. It is necessary to add extra images to deliver the desired effect. Unfortunately, analog film or digital methods at twenty-four frames or images per second also add undesirable amounts of strobing, blurring and other discontinuities of information flow to the supplemental “in between” images that are generated through double-frame printing or conventional film image compositing.

Smoothness of motion, as seen by the audience, is especially important in modern motion picture theaters. Their screens are, in many cases, fifty feet or more in width. Any finely-delineated motion projected onto such a wide screen must traverse a greater distance on that screen between images than is traversed on older screens, which were seldom over forty feet wide. In order for motion to appear smooth, it is necessary to add an extra image between each of the original images of a motion picture film. This way, the large distance displaced by each image element from one image to the next does not impart a jerky appearance to the motion picture as projected. The present invention solves this problem by using technology originally designed for a different purpose, as shall be shown.

As Weisgerber 614 teaches, motion picture feature films photographed and projected at forty-eight frames per second convey a significantly more realistic presentation of motion than do films photographed and projected at twenty-four frames per second (conventional frame rate). This difference accounts, in large part, for the novelty of Weisgerber 614 and his subsequent invention, U.S. Pat. No. 5,739,894 (other frame rates). Actual photography at forty-eight frames per second or a higher frame rate delivers an improved presentation compared to twenty-four frames per second, but only newly-produced motion pictures can be photographed at that rate. For previously-produced films or for films which could not be feasibly photographed at a high frame rate, it is necessary to enhance images originally captured at the rate of twenty-four frames per second.

It is the primary objective of this invention to produce such image enhancement. The purpose of this enhancement is to allow for the release of motion pictures that contain images that will appeal to contemporary audiences, even though the motion pictures themselves depict action that occurred and had been photographed in the past.

With advances in storage and presentation of visual information at higher frame rates, the motion picture images of the past can appear unimpressive to audiences accustomed to contemporary motion picture and television presentation. The “legacy” look of presentation at twenty-four frames per second appears nostalgic and gives the impression of the cinema art of a past era. The reaction of a contemporary audience to motion pictures photographed at twenty-four frames per second can be analogized to the impression on a listener to a recording from a previous era. The frequency response (or lack thereof) and signal to noise ratio of the old recording indicate to the listener that it is, indeed, old. While a listener may be willing to sacrifice sound quality to hear a vintage performance, it cannot be assumed that a contemporary motion picture audience would be similarly impressed with the appearance of an “old” motion picture, unless the audience specifically attends the showing of a “classic” film and nostalgia is part of the experience. With video games and other contemporary entertainment produced at the rate of thirty or sixty images per second, contemporary audiences often find the “legacy” look of films produced at twenty-four frames per second to lack sufficient realism to produce the experience they expect.

The present invention presents the appearance of immersive, high-impact motion pictures by enhancing previously-produced motion pictures to replicate the image quality typically associated with advanced motion picture technology. By using contemporary computer techniques, motion pictures that actually captured motion at the rate of twenty-four frames per second can be enhanced to appear as though the motion had actually been captured at forty-eight frames per second. This allows release of previously-produced motion pictures, with an image quality that will satisfy contemporary audiences. Thus, the motion pictures treated according to this invention can generate a new revenue stream for their owners.

The invention described here is not limited to two-dimensional motion pictures. Three-dimensional pictures can be enhanced, as well. Lawrence Lipton has called for the projection of thirty film frames or digital images per second, for improvement of the 3-D viewing experience (L. Lipton: My Lucky Frame Rate: Real D Forum, posted Apr. 12, 2006), stating that exhibition at this higher rate is needed for such an improvement. He also contemplated photographing motion picture films at forty-eight frames per second, but dismissed that frame rate as overly costly and not technically feasible, since the digital imaging techniques used in the present invention had not yet been applied in that manner. The present invention answers the concerns raised by Lipton, by delivering the sort of experience in 3-D presentation that Lipton said was not available. Therefore, it is a further object of this invention to allow for the enhancement of 3-D motion pictures at an exhibition rate of forty-eight frames or images per second; ninety-six image impressions per second (forty-eight delivered to each of a viewer's eyes). James Cameron has also called for enhancement of 2-D motion pictures for 3-D presentation: Variety, Apr. 11, 2008. The actual implementation of Cameron's suggestion, although Cameron himself could not implement it, is a further object of the present invention.

Three-dimensional motion picture presentation has been plagued by undesirable motion artifacts at the conventional projection rate of twenty-four frames or images per second. At double that rate, forty-eight frames per second, the persistence of vision allows 2-D presentation to appear smooth. The invention delivers a comparable improvement for 3-D presentation. In accordance with the present invention, the 3-D presentation of forty-eight discrete images for each eye cures the apparent lack of information in 3-D presentation, because the “dark time” associated with twenty-four frame projection is eliminated.

The practice of the invention comprises a number of separate and distinct applications, all of which feature processing of highly-realistic motion pictures through digital means. It is suitable for motion pictures in which images are photographed on film or captured digitally. It is compatible with film or digital projection. It is also suitable for two-dimensional or three-dimensional motion picture presentation. The preferred application of the invention is to enhance motion pictures originally photographed at a conventional frame rate, for exhibition after processing at double that frame rate. These motion pictures then present a significant improvement in image clarity, and in temporal and spatial resolution, as a result of the processing described here. The invention can also be practiced in reverse, with high-impact films originally produced for exhibition at a high frame rate converted for conventional presentation and featuring a traditional cinematic “legacy” appearance.

With recent advances in home video entertainment, the amount of visual information that can be presented to home audiences now approaches that available in motion picture theaters, although the full theatrical experience is not available at home. Nonetheless, the benefits of the invention described here can also be applied to home video entertainment.

### BRIEF DESCRIPTION OF THE INVENTION

The invention described here is a method for processing motion pictures for presentation with a highly-realistic appearance to theatrical audiences. It is a universal image-processing method that can be used to enhance previously-produced motion pictures to deliver an audience impact that was unobtainable through conventional exhibition. It can also be used to “down-convert” contemporary high-impact motion pictures for conventional exhibition at a lower frame rate. It is compatible with film or digital image capture, with film or digital exhibition and with two-dimensional or three-dimensional presentation. In effect, it serves as a universal bridge between image capture and motion picture presentation methods now known in the cinematic art. It can also serve as such a bridge between image capture and motion picture presentation methods yet to be developed.

The invention described here is a method for producing new motion pictures or for enhancing existing films that were photographed at twenty-four frames per second, so that they can be shown according to the invention previously taught by Weisgerber. The invention can use any film format or any digital video acquisition format. Since nearly all films that were ever commercially produced were photographed at twenty-four frames per second, the primary objective of the invention is to enhance films originally photographed at that frame rate, so that they can be projected at forty-eight frames per second with the quality of presentation that only the higher frame rate can deliver.

Mere projection at the higher frame rate cannot be accomplished with analog film technology, except by double-frame printing. This method cannot realistically simulate the motion that the camera would have captured if the original action had actually been photographed at the higher frame rate. Neither can the digital equivalent of double-frame printing, which would involve the repetition of each image. However, such realistic motion can be simulated using computerized techniques originally designed to produce additional frames to create slow-motion effects in motion pictures or digital video. The present invention goes far beyond the mere interpolation of extra frames, as will be explained.

In the practice of the invention described here, motion picture films that have already been photographed and produced for public exhibition are first digitized by conventional means known in the art. Then computerized techniques are used to generate new transitional images that are then interpolated between each successive pair of original images. In this manner, the number of images is doubled, so the resulting motion picture can be projected at forty-eight frames or digital images per second, to present forty-eight discrete images every second. These motion pictures can be shown either through conventional projection, or through digital exhibition methods, as known in the art. For conventional projection, they are converted back to film through means known in the art.

In the present invention, computer software is used to produce a transitional “in-between” image for interpolation between each pair of successive images in the original motion picture. Mere interpolation of an image that appears “half-way between” the previous image and the next image (positioned with respect to each image to be interpolated) is not sufficient to deliver the desired effect. Instead, the software used in the invention actually analyzes the apparent motion change through each sequence to generate an image to be interpolated between each image of the original motion picture and the next image of the original motion picture. Because the original images from the motion picture are in digital form when the interpolated images are added, the software enables the user of this invention to control each individual pixel of every image of the entire motion picture. These interpolated images appear consistent with the motion of the objects originally photographed. The result is the depiction of what the motion picture would have looked like if twice as many discrete images were originally captured than actually were.

The computerized techniques used in this invention impart the correct amount of motion displacement to each pixel that comprises each of the images that form the motion pictures subjected to this enhancement and conversion method. Through this technique, films that were actually photographed at twenty-four frames per second will appear as if they had originally been photographed at forty-eight frames per second. Films originally produced in the 35 mm format can also be converted to the 70 mm format by adding sufficient visual information to fully exploit the resolution available with the 70 mm film format. In the practice of the invention, information is added to the original motion picture film in four ways. First, grain is removed, thereby reducing “noise.” Next, new “in-between” images are generated and interpolated using motion vectoring, thereby adding the necessary visual information. Then, motion blur is reduced. Finally, the image is sharpened. The removal of such artifacts as grain and motion blur dramatically improves the appearance of the motion picture enhanced by this invention. In effect, these artifacts create a veil that reduces the perception of realism that the viewer of the motion picture experiences. The process described in the present invention removes the veil to provide an immersive experience comparable to viewing real life.

In a different application, computer-generated images can be added to only certain scenes or sequences in a motion picture, if desired. Under this option, other scenes would not be enhanced and would be double-frame printed, for projection of the entire motion picture film at forty-eight frames per second or digital presentation at forty-eight images per second. In other words, the added realism that stems from the motion vectoring accomplished by the software used in the invention would be imparted to certain scenes or sequences of a motion picture and left out of other scenes or sequences. This allows the filmmaker to control whether or not the artifacts that deliver the “legacy” look, such as motion blur, are actually suppressed in any specific scene of a motion picture. This is a feature of the film experience not available with conventional film methods, and only disclosed previously by Weisgerber for new films produced specifically to deliver this effect. Until the present invention, this effect was not available with any films that had previously been produced.

It should be noted that the application for the software used in the practice of this invention is different from the application for which the software was designed. The original application was to synthesize multiple images from each successive pair of original images, to simulate action captured in slow motion. In the present invention, only one “in between” image is generated and inserted between each of the original images and its successor. These transitional images have the same level of resolution as each of the original images, resulting in a smooth transition between original and new frames. In the present invention, no slow-motion effects are created. Instead, the result is an enhanced motion picture that delivers a higher level of spatial and temporal resolution than is available with conventional motion picture exhibition methods.

The present invention retains the real-time constant of the original motion as captured. With images originally captured at twenty-four frames per second, for example, projection would proceed at forty-eight film frames or digital images per second. The added images do not change the time constant of the original motion picture, but they do enhance the spatial and temporal resolution of the presentation.

It is envisioned that the primary application of the invention will be to enhance motion pictures originally produced according to conventional cinematic art for an improved presentation to audiences. However the invention can also be used in reverse to convert advanced-definition motion pictures originally photographed at a high frame rate for exhibition to general theatrical audiences in conventional motion picture theaters. In the preferred embodiment of this specific application of the invention, contemporary motion pictures originally photographed at forty-eight film frames or digital images per second are converted for exhibition at half that frame rate.

The software used in the practice of the invention was designed to produce fast-motion effects, as well as slow-motion. Using the fast-motion feature of the software, the invention described here takes each pair of successive images captured at a high frame rate and generates a single image that represents the motion that occurred during the time interval during which the two original images were photographed. Motion blur is added to simulate the appearance of conventionally-produced pictures that had this artifact as part of the presentation. Audiences for such pictures would see a motion picture that looked exactly as if it had originally been photographed at the lower frame rate, twenty-four frames per second in the preferred embodiment. Thus, contemporary motion pictures, photographed at a higher-than-conventional frame rate and usually produced only for special-venue exhibition, could be shown in conventional motion picture theaters. Release of this sort would make such motion pictures available for viewing by mass general audiences, thereby adding an additional source of revenue for the owners of those motion pictures.

In addition, motion pictures processed according to this application of the invention can also be used for home video entertainment purposes. There has been some experimentation with a home video format of forty-eight images for home entertainment use, both as a new format capable of delivering an enhanced picture and as a means for delivering three-dimensional video entertainment to home audiences. The present invention is suitable in connection with these applications.

While it is also envisioned that most films enhanced according to the invention described will be two-dimensional motion pictures, the invention can also enhance three-dimensional films. In effect, where the original motion picture contained only twenty-four images for each second of running time for left eye and right eye, the same film after enhancement according to this invention would contain forty-eight such images for each eye. Using the computerized techniques described, viewers of a 3-D picture would enjoy the same image clarity and smoothness of motion that viewers of a similarly-enhanced 2-D picture would enjoy, with the addition of the 3-D effect.

### BRIEF DESCRIPTION OF THE DRAWINGS

FIG. 1 shows five frames of motion picture film, lettered A through E. A vertical line is shown in each frame to illustrate movement of that line across the frame's field of view.

FIG. 2 shows nine frames; the five frames shown in FIG. 1, plus four other frames interpolated between them. Again, a vertical line is shown in each frame to illustrate movement of that line across the frame's field of view.

FIG. 3 shows five frames, generated from nine images comparable to those shown in FIG. 2, as if the images of FIG. 2 represented original motion picture images, for exhibition at a lower frame rate. Again, a vertical line is shown in each frame as in the two other drawing figures.

It should be noted that the drawings are presented in a highly simplified manner. The images that are enhanced in the actual practice of the invention are far more complex, due to both the inherent complexity of the images themselves and the motion vectoring process used in the enhancement of those images. Only picture information is represented in the drawings. Audio, control and any other non-picture information that might be contained on a strip of film is not depicted.

### DETAILED DESCRIPTION OF THE INVENTION

The preferred application of the invention is the enhancement of previously-produced motion pictures; usually motion picture films, for presentation that delivers a level of image clarity, spatial and temporal resolution, comparable to state-of-the art motion picture theatrical exhibition.

For enhancement of existing motion picture films to be shown at a frame rate of forty-eight frames per second of higher, the films are converted from analog to digital form by any means known in the conventional art. In addition, if a motion picture was originally photographed for exhibition in the 35 mm format, it is also necessary to add sufficient picture information to allow reformatting onto a 70 mm film format without loss of picture quality. The process for this enhancement, as described previously, comprises suppression of grain, interpolation of new transitional images generated by motion vectoring, reduction of motion blur and sharpening of the resultant image.

This technique is also suitable for images originally captured in digital form. If images are originally captured in a nonstandard digital format, they may be reformatted into a format that is generally accepted and known in the art. Means for accomplishing this are also known in the art.

Once the images are in a generally-accepted digital form, a new image is generated for interpolation in a new “in-between” frame, between each image of the original motion picture and its successive image. These “in between” frames are actually new discrete images, generated by computer software. Retimer®, developed by Reelviz, S.A., is suitable for this application. The advantage of Retimer® lies in the manner in which the program generates the additional images for insertion into the image sequence. The program analyzes the movement of each individual pixel of information, through a sequence of primary images that comprise part of the original motion picture. It should be noted that the promotional literature for Retimer®, as found on the company's web site, www.realviz.com, does not mention the application proposed in the present invention as suitable for the Retimer® software. While Retimer® was originally used in the invention, any other software that could perform the same function in a similar manner is also acceptable. This includes software that will be developed in the future.

The essential feature of the software is that it generates new images that have the same level of clarity and resolution as the images that comprise the original motion picture. Although the software was originally designed to produce slow-motion effects, the invention described here uses it in an entirely different manner and for an entirely different purpose. In the present invention, only one new image is generated and inserted between each of the original images and its successor. This is done for the entire run of the motion picture; not just for scenes where special effects are to be added. This effect can also be modulated selectively to switch between state-of-the-art presentation at the higher frame rate and the appearance of conventional “legacy” presentation at the original frame rate. The result is not a special slow-motion effect that is generated for only a few selected sequences of a motion picture, but an enhanced presentation of the entire picture.

Because of the software employed in the invention and the way it works, the transitional “in between” images have the same level of clarity and native resolution as the original motion picture. A motion picture enhanced according to this invention will appear as if the motion it depicts had actually been captured at twice the frame rate at which the actual motion was originally photographed. For example, a conventional motion picture is photographed on film at twenty-four frames per second. After it is enhanced according to the invention, the resulting picture will appear to present exactly the motion that would have been captured at forty-eight frames per second, had the camera originally captured forty-eight film frames during every second. Because the native resolution of the “in-between” images equals that of the primary images, the entire motion picture delivers the image clarity and transparency that would exist for a motion picture photographed at the higher frame rate; forty-eight frames per second in this case.

Software typically used for slow-motion (and fast-motion effects), such as Retimer®, is suitable for the practice of the present invention, although any other software that performs the same function can also be used. Any software developed after Retimer® that generates images in a similar manner should also be considered as lying within the scope of the invention. It should be noted that the Retimer® software was originally intended to generate a series of several “in-between” images, for insertion between one image of the original film and the next, to produce the slow-motion effect during specific sequences of a motion picture. In the present invention, the software is used for an entirely different purpose: to produce a single intermediate image between each of the original images captured on film or digitally during photography. Thus, the enhanced motion picture contains double the amount of visual information as the original film, before any format adjustments are made to accommodate exhibition. In addition, the higher rate of image exhibition significantly improves the smoothness of motion. There is also a positive synergistic effect on the audience, delivering a benefit beyond the sum of these two effects. With the addition of picture-enhancement processing to “clean up” the images, if required, the result is a significant improvement in temporal and spatial resolution as perceived by the viewers of the motion picture when it is presented at the higher frame rate.

With the higher display rate (forty-eight frames or images per second in the preferred embodiment), the audience will perceive at least twice the spatial and temporal resolution than was originally captured, due to the doubling of visual information (new images) and enhancement of those images. For example, a film originally photographed on 35 mm film can be projected in the 70 mm format after enhancement according to the invention. This presentation requires use of a projector with 48 frame-per-second capability as envisioned by Weisgerber in U.S. Pat. No. 6,243,156 (2001). For digital presentation, the motion picture will be projected in the standard 2K digital cinema format (1080×2048 pixels), but will appear to have the same clarity and fidelity as if it were shown in 4K format, with four times the native resolution of the digital 2K projector. This enhancement of temporal and spatial resolution, along with suppression of motion blur due to the large number of images shown per second, appears similar in quality to film projection in the 70 mm exhibition format. The overall impression on the viewers of motion pictures presented in both formats is comparable.

As an example of the invention in practice, consider an object (part of an image) depicted in a motion picture that appears to move from left to right across the screen upon which the motion picture film is projected. In the conventional art of twenty-four frame-per-second presentation, the object would be seen twenty-four times each second, at different places on the screen. Had the movement of the object instead been captured at forty-eight frames per second, there would have been twice as many images of the object, and the object would appear to move approximately half as far from one image to the next than in the twenty-four frame-per-second example.

If the image of the object were to travel across the screen at a constant velocity, the newly-interpolated images would appear exactly half way between each pair of successive images in the original film. However, actual motion in real life entails accelerations and decelerations. The software calculates these accelerations and decelerations and generates new images that accurately depict the actual locations of all objects photographed, as they would have actually appeared if twice as many images had been originally captured than actually were.

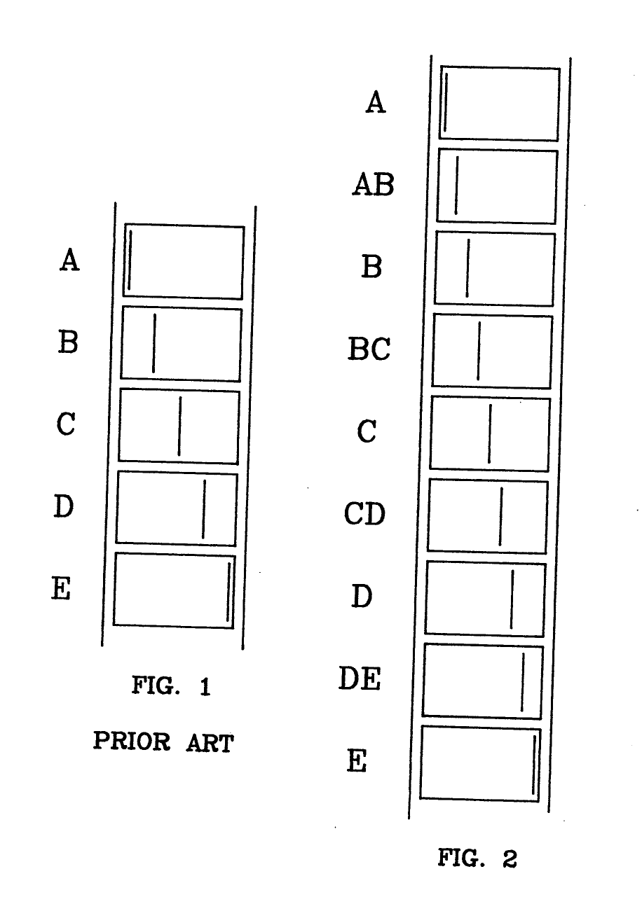

The effect of the interpolation and motion vectoring of these synthesized images can be seen by referring to the drawings. FIG. 1 shows five frames of a motion picture, lettered A through E. These frames represent a short sequence of an existing motion picture, of up to feature length. Instead of the live action that would typically be photographed, FIG. 1 shows a vertical line moving across the field of view represented by the frames in the drawing. In Frame A, the line is at the left side of the frame. It moves one quarter of the distance to the right at Frame B, one half of the distance to the right at Frame C, three quarters of the distance to the right at Frame D, and is located at the right side of the frame at Frame E. It should be noted that, the wider the screen onto which the motion picture is projected, the greater the amount of distance traveled between the positions of the line from one frame to the next. This disparity of displacement causes objectionable stroboscopic effects when conventional motion picture films are projected at twenty-four frames per second onto large theatrical screens. The larger the screen, the more objectionable the disparity of displacement becomes.

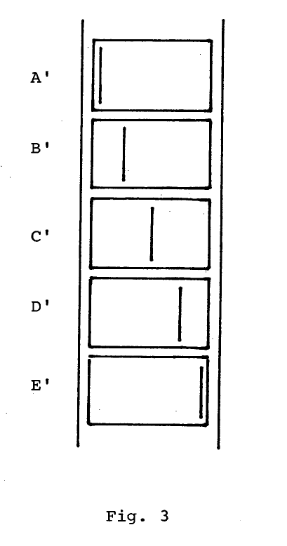

FIG. 2 shows the same image sequence, after enhancement according to this invention. The same five images from FIG. 1 are shown, but there are now added four new images, one placed between each of the original images. Images AB, BC, CD and DE are new transitional images generated by the computer software and designed to appear as if they were discrete images. These images appear the way they would look if they were photographed at double the original frame rate of photography; typically forty-eight frames per second, instead of twenty-four. This process is repeated for the entire length of the motion picture to be enhanced for exhibition. It should be noted that the position of the vertical line has moved approximately half the distance between images, compared to the smaller number of frames in FIG. 1. This reduced disparity of displacement from one image to the next cuts down significantly on the undesirable stroboscopic effects inherent in projection at conventional frame rates onto large theatrical screens. It should be noted that the illustration in the drawings is greatly simplified. Since the pixels that comprise actual images move at differing velocities from one image to the next, it is necessary to analyze the actual horizontal and vertical displacements of each pixel over a short amount of time and generate in-between images that precisely replicate the motion of the objects depicted. That is the process followed in the present invention.

The depiction of the lines in the newly-formed images is simplified for illustrative purposes. If the line in the illustration had been an actual object in a sequence of motion picture images, its placement on each interpolated image would be determined by the capability of the software to analyze motion, and would represent the actual position that the object would have assumed if it had been photographed at the actual frame rate of projection. The word “approximately” in the previous paragraph is critical. In reality, objects that appear to move across the motion picture screen accelerate and decelerate during the apparent journey. If an object actually moved at a constant velocity throughout its range of motion, then each object in the interpolated image would appear exactly half way between its position in the previous image and its position in the next image. Any method that would generate interpolated images that appear to place all objects exactly half way between their locations in the previous image and their locations in the next image would introduce errors; because it would fail to take into account the accelerations and decelerations of the objects as they were photographed.

For example, consider a ball thrown by a person seen on the left side of an image, to another person seen on the right side of the same image. The ball is thrown toward the recipient and with an upward component, so it rises in altitude, and then falls again, to reach an altitude at which the recipient can catch it. From the time the ball is thrown until it reaches its zenith, it is decelerating. Between any two time points, there is a forward (horizontal) component and an upward (vertical) component to the motion of the ball. Because the ball is moving toward the zenith of its trajectory, the vertical component of its motion decreases, resulting in a deceleration of upward motion. After the ball has reached its zenith, it begins to fall. At that time, the downward (vertical) component of its motion (caused by gravity) increases, as horizontal motion toward the recipient continues.

The software used in the present invention divides the motion of the objects that form an image composed of a multiplicity of pixels into intervals one twenty-fourth of a second long, in the preferred embodiment of the invention. The images formed this way correspond to each frame of a motion picture. Within each such increment of motion, the software analyzes changing velocities of each of the objects that comprise each image and determines the position of each such pixel at the midpoint in time between the previous original image and the next original image in sequence. Accordingly, the result is a highly accurate representation of the actual scene as it would look if it had actually been photographed at double the frame rate at which the images were originally photographed or produced. In other words, if a motion picture originally photographed at twenty-four frames per second is processed according to the invention described here, the result would look the way the same picture would have looked if it were actually photographed at forty-eight frames per second. In this manner, artifacts present at the lower frame rate would be suppressed. The viewers of motion pictures enhanced according to this invention would see motion as it would actually have appeared, not a pseudo-motion synthesized by interpolating images exactly half-way between the previous and next image in the original motion picture, whether or not the “half-way” images accurately depicted the motion captured when the motion picture was originally photographed.

The software used in the practice of the invention can produce images that duplicate the scene as it actually would have appeared at the moment in time exactly halfway between each image and its successor by controlling each pixel individually. The software calculates motion vectors for each individual pixel or group of pixels, and estimates the actual displacement of each such pixel from one image to the next. Each pixel is moved in the horizontal and vertical directions by the appropriate amount from one original image to the new image halfway between the previous original image and the next one. The amount that each pixel is moved is determined by the recent history of displacement of that pixel over the run of recent previous images and upcoming subsequent images. In other words, the software analyzes the displacement of each pixel from image to image, taking into account the velocity of that pixel at any given image (first time derivative of the displacement) and any changes in velocity that occur in the movement of that pixel (second time derivative of displacement). In that way, the displacement of every pixel is charted for each image of the entire motion picture. Given these motion vectors for each pixel, the software produces a precise “in between” image for interpolation between each original image and its successive image of the original motion picture. Thus, it replicates what the motion picture would have actually looked like if it had been photographed at double the frame rate at which it had originally been photographed or produced. The software also permits manual adjustment of the location of any pixel or group of pixels to modify the image that the software presents as a potential new “in-between” image. Therefore, the user of the invention described can produce the entire set of interpolated images, pixel by pixel, resulting in an enhanced motion picture that has twice as many images as the same motion picture originally had. The improved picture appears exactly as it would have appeared, if it had originally been photographed or produced at the higher frame rate.

It is envisioned that the addition of a new transitional image between each of the original images of a motion picture will be administered throughout the enhancement of an entire motion picture in the practice of the invention. Still, there are certain exceptions to this rule that leave such parameters as lighting effects and impartation of contrast under the control of the filmmaker during filming.

Thus far, the description of the invention has centered on two-dimensional motion pictures. Most motion pictures were produced for 2-D exhibition, and it is expected that the vast majority of motion pictures enhanced according to the invention described here will be 2-D films. The invention can also improve three-dimensional motion pictures, however.

Generating new images for interpolation between original images, when the “in-between” images accurately present the scene as if it were actually photographed at double the original frame rate provides a significant improvement to the 2-D motion picture experience. For 3-D exhibition, there is an additional problem with conventional frame rates, such as twenty-four frames per second. With twenty-four images shown to the each of the viewer's eyes, the limitation of persistence of vision precludes the viewer from perceiving motion as smooth in 3-D presentation. See Lipton, infra. Motion appears unnatural, resulting in viewer discomfort. In effect, this is comparable to the artifacts, such as flicker and motion blur, that plague 2-D presentation, but their effects are compounded in 3-D presentation mode. The present invention doubles the number of images, and consequently the amount of visual information presented to each eye of the viewer. This permits the viewer to perceive motion as smooth and natural during 3-D presentation.

Conventional 3-D motion pictures are photographed with two cameras, placed to simulate stereoscopic viewing. The process described here improves the temporal resolution delivered in 3-D presentation. In the practice of the invention, the software determines the placement of each pixel of each image, as it would appear for left-eye or right-eye viewing if image capture had taken place at a high frame rate, such as forty-eight frames per second. The result is forty-eight discrete images for the left eye and forty-eight discrete images for the right eye during each second of the run of the picture, resulting in a significant reduction of the undesirable motion artifacts that degrade most discrete methods of 3-D presentation.

There are several methods currently used for 3-D projection. A single digital (DLP) projector is used for projection at twenty-four frames per second. For higher-quality presentation at forty-eight frames per second, two synchronized film projectors or two synchronized digital projectors are employed. Since the invention described here relates to the processing of images for projection, any suitable projection system is compatible with the invention. This applies to current projection systems, as well as projection systems to be developed in the future.

Another application of the invention facilitates adding foreign-language subtitles to motion pictures for release to audiences who speak a language other than the one used for recording the sound component of the motion pictures in question. Subtitles in various languages are currently included with picture, sound and other necessary information as part of a package for digital presentation of these motion pictures. The time code that forms part of the total information package for the picture adds foreign-language subtitle information in the desired language and at the appropriate time to translate the words spoken as part of the story line of the motion picture.

Digital projection at forty-eight images per second or another similar high rate, using progressive scan, improves the ability of the viewers of the motion picture to see and read the foreign-language subtitles. With conventional 3-D production, the subtitles appear to become lost at a depth not corresponding to the dimensionality of the motion picture presentation, because the displacement between the eyes of a viewer causes that viewer to perceive the action of the motion picture as occurring in certain planes, while the subtitles appear not to be located in any of those planes. This perception renders the reading of the subtitles difficult. Through the use of a progressive scan, coupled with a high rate of image presentation, subtitles appear properly aligned with an exact coincidence of positioning.

With the post-production method described here, the delivery of forty-eight discrete images per second to each eye of the viewer produces benefits comparable to those obtained in 2-D presentation. Compared with presentation at twenty-four frames or images per second, undesirable motion artifacts are eliminated and motion appears much smoother. Temporal resolution is more fluid, because each picture element is displaced by less space from one image to the next. There is also improved spatial resolution, because double the amount of picture information is presented, compared to conventional exhibition methods.

After the conversion and enhancement processes have been completed, the resulting motion picture is in digital form. It is then either projected digitally according to methods known in the art, or it is converted back to an analog film format for projection at a high frame rate, preferably forty-eight frames per second. In the preferred film-presentation embodiment of the invention, the 70 mm theatrical film format is used, with five perforations per frame, and with the image on the film stretched anamorphically upon projection to the equivalent of an eight-perforation frame. This creates a taller image and one with a more “square” aspect ratio than the 2.21 to 1 normally found in the 70 mm format with five perforations per frame. Therefore, the motion pictures enhanced according to this invention will utilize more screen height than does the five-perforation 70 mm film format, which delivers a “letterbox” look. The films prepared for exhibition according to this invention can be stored on 70 mm film in the five-perforation format, anamorphically compressed and expanded upon projection.

In the present invention, projection proceeds at forty-eight frames per second, and the use of a double-bladed shutter on the projector delivers the display of ninety-six impressions per second to the viewers of the film. This renders the present invention compatible with Weisgerner 614 (1997), in which films are projected at the rate of forty-eight frames per second. The present invention allows forty-eight discrete images to be delivered to the audience every second during the entire film presentation, as previously disclosed and claimed. As perceived by the viewers of the film, the forty-eight images presented every second appear to fully depict the scene as if it were actually photographed at forty-eight frames per second. Projection must be accomplished at forty-eight frames per second or a higher frame rate, or its digital equivalent, to achieve the desired result. Either analog or digital projection methods can be used in accordance with this invention.

The use of a double-bladed shutter at forty-eight frames per second further improves the quality of the images delivered to the audience, since it allows for a significantly higher light level than is available with projection at twenty-four frames per second (forty-eight impressions per second with a double-bladed shutter). This results in higher image contrast and improved color rendition. In addition, light levels of at least seventeen and up to twenty-three footlamberts are achievable without projection flicker, as compared to the conventional flicker threshold of twelve to sixteen footlamberts. This increased level of screen brightness is available with the use of a double-bladed shutter, because the delivery of ninety-six impressions per second eliminates flicker and other artifacts sufficiently to allow the brighter light level without objectionable artifacts.

The benefits obtainable through the use of a double-bladed shutter at forty-eight frames per second can be achieved by using a projector capable of accomplishing pulldown in an interval of five milliseconds or less; twice as fast as can be done by a conventional Geneva-movement projector. This technique was previously disclosed by Weisgerber in U.S. Pat. No. 5,627,614 (1997).

The invention described delivers enhanced versions of films produced in the 35 mm format by augmenting the information packing density associated with the 35 mm format, to the level available with the 70 mm film format. In effect, the method described here adds more information to existing films, so the audience will perceive more visual information than was placed onto the original film when it was produced. While it is envisioned that the invention described will be used primarily with motion pictures produced through film methods known in the art, the invention is also suitable for enhancement of motion pictures produced through 24P digital production acquisition, with its information storage capability of 1080×1920 pixels.

Motion pictures enhanced according to the method described here can be exhibited in any format capable of delivering a presentation with the enhanced temporal and spatial resolution that is the primary object of the invention. While many motion picture films are still photographed in the 35 mm film format, the invention described here delivers the quality of presentation associated with the 70 mm film format, which allows for considerably more information storage than is available on 35 mm film. Therefore, films enhanced according to the invention can be exhibited in the 70 mm film format, with anamorphic adjustment of the aspect ratio if desired, with the full measure of audience impact associated with the large film format. Other large film exhibition formats, such as IMAX, can also be accommodated in the practice of the invention. So can digital exhibition in the 2K (1920×1048 pixels) or larger digital formats.

In addition to the two-dimensional formats just mentioned, the invention is also suitable for delivering an enhanced three-dimensional presentation, due to the amount of picture information added to the original motion picture by the processing that constitutes the invention. Thus, the processing of motion pictures in accordance with the invention described here serves as a “universal” preparation for high-impact presentation in any suitable format; film or digital, two-dimensional or three-dimensional.

The beneficial effect of this invention can also be imparted selectively to specific scenes or sequences of a motion picture. When the user of the invention desires to have the audience perceive the full impact available, the invention is used to enhance only those specific scenes or sequences. For other scenes or sequences, the original frames would be double-frame printed. This retains the artifacts inherent in double-frame printing, that the present invention is designed to eliminate. Thus, these artifacts can be either eliminated or retained for any specific scene or sequence of a motion picture. As with the previous Weisgerber inventions, the benefit can be imparted and removed selectively when enhancing a previously-produced motion picture.

The present invention also allows previously-produced stock footage, often stored in film libraries and film studio collections), to be enhanced in a cost-effective manner for use in new film production. By using the invention described, such “stock” film sequences, photographed at twenty-four frames per second, can be converted to appear as if they had been photographed at forty-eight frames per second. The motion vectoring feature simulates the look that would have been captured on the film if photography had been accomplished at forty-eight frames per second. Such “stock” sequences can then be used in connection with the production of new motion picture films, with no loss of image quality due to the use of images that had been recorded in an “old” format and through an “old” method.

The invention calls for digital enhancement methods and computerized image creation to add sufficient information to each image to accommodate the 70 mm format, as well as generating new images to fit between each of the previously-photographed images. In this manner, conversion can be accomplished efficiently and without loss of light, image clarity or resolution associated with optical conversion methods. The method described reduces grain and improves apparent resolution, resulting in an immersive presentation, which delivers the image clarity associated with real life. The benefit of the invention is also available through the digital equivalent, also comprising inserting new additional images between each of the images of the original motion picture. Motion pictures enhanced according to the invention, whether exhibited in film or digital formats, are projected with a light brightness of seventeen footlamberts or more in the preferred embodiment. This is brighter than the SMPTE standard of sixteen footlamberts for conventional twenty-four-frame presentation at forty-eight flashes of light per second. A range of twenty-three to twenty-five footlamberts is possible. Presentation at this brightness level delivers a more realistic visual presentation than is available at conventional SMPTE brightness levels.

The invention described permits the showing of a previously-produced motion picture film with the level of picture clarity consistent with new motion picture production. Contemporary film standards now render the conventional frame rate of twenty-four frames per second inadequate to sufficiently suppress undesirable artifacts such as stroboscopic effects. With the actual analysis of motion vectors between each frame, however, the interpolated images developed in accordance with this invention eliminate stroboscopic effects by duplicating the motion that the camera would have actually captured if it had operated at the higher frame rate in the first place.

In addition, the amount of magnification now used in the motion picture art requires the level of image quality consistent with the practice of this invention. Magnifying an image on 35 mm film to a screen larger than forty-five feet wide only displays the shortcomings of the 35 mm film format. Use of the 70 mm format delivers a high-quality presentation on screens up to eighty feet wide. On screens that large, however, interpolation of motion cannot be acceptably smooth for any fast motion projected at twenty-four frames per second. The displacement between frames is too large. With the present invention, the actual displacement of an object on the screen is calculated, and objects are shown precisely at the correct location on every new “in-between” image. This result is not available through other means.

Another collateral benefit of this invention is that the dynamic image enhancement described also reduces grain, sharpens images and produces an image with a superior appearance on large theatrical screens, compared to those available through conventional means. With conventional film technology, there is more objectionable grain and lower apparent resolution than with the present invention.

Digitizing the film images before engaging in the enhancement process improves the impact of a theatrical motion picture presentation without sacrificing picture quality. This reduction of picture quality is inherent in optical enlargement of films originally produced in the 35 mm film format and converted to the 70 mm film format. In effect, the change in formats is done much more efficiently with digitized images than with conventional film images. In addition, the impartation of transitional images that effectively produce the actual appearance of a motion picture that has been photographed at double the original frame rate of the original motion picture is only available through use of the invention described here.

The present invention comprises a number of novel elements. Images that were previously photographed on film or digital media are digitally processed and enhanced in a manner not previously practiced in the cinematic art for the purpose of high-frame rate presentation. Effects software is used for a completely new purpose, to produce fully realistic transitional images and present greater perceived resolution. The level of temporal and spatial resolution perceived by motion picture audiences is enhanced significantly through the use of the present invention, whether the enhanced film is a two-dimensional or three-dimensional motion picture.

While the primary application of the invention is the enhancement of previously-existing motion pictures to deliver an improved audience effect, it can also be used to reduce costs and save effort in the production of new motion pictures. Without the use of the method described here, motion pictures produced to deliver a high-impact presentation must be photographed at a high frame rate, such as forty-eight frames per second. Film photography at that speed requires a large amount of film stock, and digital photography at that speed takes up a large amount of data storage capacity. Post-production and other post-photography operations are also more expensive, labor intensive and time-consuming, due to the extra images or data used to capture the motion depicted.

In this application of the invention, original motion pictures are photographed, either on film or digital media, at a conventional frame rate. Typically, this would mean twenty-four film frames or digital images per second. Post-production, editing and special effects production proceed according to the conventional cinema art, using the images captured at the conventional frame rate. At that time, the motion picture in question is then processed for enhancement according to the invention, as if it were a “previously-produced” motion picture.

The result would be nearly identical to a motion picture originally photographed at a high frame rate such as forty-eight frames per second, without the motion blur present at lower frame rates such as twenty-four frames per second, and later presented to audiences at that same speed. All of the benefits of motion capture at a high frame rate are presented to the audience, but the cost of photography and production is significantly lower; comparable to costs for conventional motion pictures. This is true for motion pictures photographed on film or on digital media. It is also true for both two-dimensional and three-dimensional motion picture production. There is an extra cost saving for 3-D motion pictures, compared to the cost of photography through two cameras at forty-eight frames per second.

Although it is envisioned that the invention described here will be used primarily for enhancement of existing motion pictures for an improved presentation with a greater degree of audience impact than is currently available, the method can also be used in reverse to convert motion pictures photographed at a high frame rate for general release in conventional motion picture theaters.

In his previous work, Weisgerber has taught the use of high frame rates, particularly forty-eight frames per second (U.S. Pat. No. 5,627,614 (1997); other frame rates in U.S. Pat. No. 5,739,894 (1999)) for producing original motion pictures that would deliver a level of audience impact greater than that available through conventional photography at twenty-four frames per second. The previous inventions involved either photography at the higher frame rate or post-production image processing to prepare a motion picture for exhibition at the higher speed.

As previously disclosed and taught, the method for producing these “high-impact” motion pictures was suitable only for theaters equipped for exhibition of such pictures, although such exhibition only required modification of conventional Geneva movement projectors. The special equipment required for nonstandard high-impact film formats, such as IMAX, was not required in the previous Weisgerber inventions. Still, these inventions did not teach the conversion of films produced according to them for general release in conventional motion picture theaters not equipped to present such motion pictures.

In the practice of this application of the invention, motion pictures produced according to the previous Weisgerber inventions can be converted from a format for exhibition at a high frame rate to a format for exhibition at a conventional frame rate. The Retimer® software is used to generate a motion picture with fewer images than were originally photographed. In this way, motion pictures produced for exhibition at a high frame rates such as forty-eight frames per second can be converted for exhibition at a conventional frame rate such as twenty-four frames per second. It should be noted that, while Retimer® software was used in the original demonstration of this invention, any other software that performs the same function with similar or better attributes can also be used.

Through the same analysis of the displacements of each pixel of each image from one image to the next, the software determines where each pixel would be placed on an image that represents the motion of each such pixel through the span of two successive images. Images are then generated with each such pixel in its correct location. In other words, the technique used by the software to generate extra images in the prior application of the invention would be used in reverse; to synthesize a single image representing the motion that took placed during the time span of each successive pair of images the comprised the original motion picture. Thus, the number of images for exhibition in this application of the invention would be half of the number of images in the original motion picture. More specifically in the preferred embodiment, the converted picture would contain only twenty-four images during each second, instead of the forty-eight discrete images contained in each second of running time of the original picture.

The previously-described step yields a more realistic look than is available by compositing each two successive images in the original motion picture, because the motion seen by the audience would appear more realistic. However, another step is necessary to replicate the appearance associated with twenty-four frames per second or similar frame rates. That is the selective impartation of motion blur as an added artifact.

This application of the invention can be shown by referring to the drawings. Consider FIG. 2 as representing nine frames of a motion picture, each image being one of forty-eight (or a number representing another high frame rate) photographed during each second of the duration of the motion picture. Therefore, for this description, Frames A, AB, B, BC, C, CD, D, DE and E are discrete images. There are also other images before and after the short sequence depicted in FIG. 2, but these images are not shown. FIG. 3 shows five newly-generated images A′, B′, C′, D′ and E′ which represent a sequence with fewer images for exhibition at a lower frame rate. Each such image represents the motion captured by two successive images in the original motion picture. In the preferred embodiment of the invention, the frame rate of the sequence in FIG. 3 is half the frame rate of the sequence in FIG. 2. Each of the images in FIG. 3 represents a new image generated by analyzing the motion of each pixel of information in preceding and succeeding images. For example, Image B′ in FIG. 3 represents the analysis of the motion from before Image AB to after Image BC in FIG. 2. Each of the images in FIG. 3 represents what the motion would look like if it were actually captured by the camera at the moment represented by each of the images in FIG. 3 and beyond (earlier and later) for the time of the entire motion picture. It should be noted that the images of FIG. 3 are not identical to their counterparts in FIG. 2. They do not represent exactly the midpoint of all motion between preceding and succeeding images. In addition, the normally-undesirable artifact of motion blur is added to give the appearance of a motion picture actually photographed at the lower frame rate, typically twenty-four frames per second. Because of this, the converted images in FIG. 3 are not identical to their counterparts of FIG. 1, due to the addition of motion blur. This illustrates the difference, albeit slight, between original images captured at a low frame rate for exhibition at a higher frame rate, and resultant images converted for exhibition at a low frame rate from original images captured at a higher frame rate.

In the conventional art, films are photographed at twenty-four frames per second, through, a 180° shutter. This means that the shutter is open half the time, allowing exposure of the film for half the time, and closed during pulldown from one frame to the next. Essentially, the film is exposed for one twenty-fourth of a second and the motion that occurs during the next twenty-fourth of a second is not recorded by the camera. This abrupt transition from one frame to the next creates the artifact of motion blur, which the people viewing the motion picture notice.

In the practice of this application of the invention, the software is used to impart the precise amount of motion blur that would have existed, had twenty-four images been photographed during each second, with a blanking period between images equal to the exposure period for each image. That way, the resulting motion picture appears as if a camera, shooting at a conventional frame rate of twenty-four frames per second in the preferred embodiment, had originally been used to photograph the motion picture.

In the contemporary art of motion picture photography, a shutter which is open slightly more than half of the time (188° open and 172° closed) has been used to make motion appear smoother during camera panning to follow action. The software can accommodate this look, by adding a correction to simulate the appearance of motion captured through such a camera, although manual retouching on a frame by frame basis may be necessary to partially or fully eliminate motion blur.

In this manner, a motion picture originally produced for high-impact presentation at a high frame rate can be converted for exhibition at a conventional frame rate on a conventional film or digital projector. This application renders motion pictures produced for high-impact or special venue presentation available for general release in conventional theaters. This feature would make such pictures available to a wider audience than could view them in their original format. In addition, such general release would allow for wide distribution of such pictures, thereby also strengthening the market for high-impact presentation of the pictures in theaters equipped to show them in the original format.

While the basic invention and the preferred embodiment have been described, this description should be thought of as illustrative and not limiting. Other frame rates, such as fifty or sixty frames per second, can be used. So can other film formats. Other embodiments are also possible, and they should be thought of as lying within the scope of the invention.

The invention claimed is:

1. A method for preparing previously-produced motion pictures for projection at a higher frame rate than that in which such motion pictures were originally produced, to audiences in motion picture theaters, with the effect of improving the presentation of said motion pictures to the members of such audiences, the method comprising:
converting each of the images in said motion picture to a digital format; generating new images, each of which accurately depict the scene that would have been captured at a time interval half way between the appearance of each original image and the next successive original image in said motion picture film; interpolating said transitional images between each original image of said motion picture film and its successive image; converting said motion picture to an analog or digital form suitable for projection; and projecting said motion picture in its entirety at double the frame rate at which it was originally produced.

2. The method as in claim 1, in which said new transitional images are generated using computerized imaging techniques.

3. The method as in claim 2, in which said new transitional images are generated using software that analyzes the apparent motion of each pixel of each image which comprises said motion picture, and generates new images that depict the actual motion of each of said pixels, with the result that each of said new images would maintain the identical appearance to that which each such image would have had if said motion picture had actually been photographed at the same speed at which it is projected.

4. The method as in claim 1, in which certain scenes or sequences would comprise a single motion picture are enhanced according to the method as in claim 1, while other scenes or sequences which comprise the same motion pictures are not enhanced.

5. The method as in claim 1, in which motion pictures originally produced for projection at twenty-four frames per second are prepared according to the method described for projection at forty-eight frames per second.

6. The method as in claim 5, in which motion picture films prepared according to the method described are projected through a double-bladed shutter.

7. The method as in claim 6, in which films prepared according to the method described are exhibited to audiences in any 70 mm film format.

8. The method as in claim 7, in which said films are stored on motion picture film in a 70 mm, five-perforation format and anamorphically expanded to a 70 mm, eight-perforation format when projected to audiences in a motion picture theater.

9. The method as in claim 1, in which in which previously-photographed motion picture film sequences are enhanced according to the method as in claim 1, for insertion into motion pictures as components of such motion pictures.

10. The method as in claim 1, in which said motion pictures are exhibited using digital projection techniques.

11. The method as in claim 10, in which said motion pictures are exhibited at the rate of forty-eight images per second.

12. The method as in claim 1, further comprising preparation of said motion pictures for three-dimensional motion picture presentation and exhibition.

13. The method as in claim 12, where such presentation comprises the projection of each of the images of said original motion picture, in addition to each of the images generated for inclusion between each of the original images of said motion picture, for viewing through each eye separately and sequentially by the viewers of said motion picture.

14. The method as in claim 13, in which forty-eight discrete images are presented for each eye separately to the viewers of said films during each second of the duration of said motion picture.

15. The method as in claim 14, in which said motion picture films are projected at the rate of forty-eight frames per second.

16. The method as in claim 15, in which said motion picture films are projected through a double-bladed shutter.

17. The method as in claim 14, in which said motion picture films are shown in a 70 mm film format.

18. The method as in claim 17, in which said films are stored on motion picture film in a 70 mm, five-perforation format, and anamorphically expanded to a 70 mm, eight-perforation format when projected to audiences in a motion picture theater.

19. The method as in claim 13, in which said motion pictures are projected through digital means.

20. The method as in claim 3, in which said software was originally designed to create slow-motion effects.

21. The method as in claim 1, in which said motion pictures are projected at a level of screen brightness of seventeen footlamberts or more.

22. The method as in claim 3, in which said motion pictures are not displayed in motion picture theaters, but are used instead, for home video entertainment purposes.

23. The method as in claim 1, further comprising the photography, post-production, editing and special effects production of motion pictures at a frame rate commonly associated with conventional motion picture photography, before subsequently preparing said motion pictures according to the method described in claim 1.

24. The method as in claim 23, in which said frame rate is twenty-four frames per second.

25. The method as in claim 24, in which the images that comprise such motion pictures are photographed on film or captured on digital media.

26. The method as in claim 10, in which said motion pictures are not photographed onto film, but are photographed instead onto digital media.

27. The method as in claim 1, further comprising the addition of foreign-language subtitles onto the time code for such motion pictures, and the presentation of such motion pictures with said subtitles added.

28. The method as in claim 27, in which said motion pictures are digitally projected at the rate of forty-eight images per second through the means of a progressive scan.

29. A method for converting motion pictures originally produced for exhibition at a frame rate higher than that used for conventional theatrical motion picture presentation, for exhibition at a frame rate used for conventional theatrical motion picture presentation comprising the use of computer software to generate images, each of which locates each pixel of each such image at the exact point where each such pixel would have been located if each such pixel had been originally captured at such lower frame rate; said motion pictures having been prepared for general release in motion picture theaters.

30. The method as in claim 29, in which motion pictures photographed or otherwise created at forty-eight frames or images per second are converted for exhibition at the rate of twenty-four frames or images per second.

31. A method for preparing motion pictures for enhanced presentation at a higher frame rate than the one in which said motion pictures were originally intended to be presented, in which the means for enhancing said motion pictures comprises the creation of new images that replicate the appearance that each such new image would have had if it had been part of a motion picture originally photographed at double the frame rate at which said picture was actually photographed, and the interpolation of each such new image between each successive pair of images which comprise the original motion picture.

32. The method as in claim 31, in which said image creation is accomplished by means of computer software designed to produce slow motion effects, rather than to create said images for interpolation between each successive image pair that comprises said original motion picture.

33. A method for converting previously-produced motion pictures for exhibition to audiences at double the frame rate at which said motion pictures were originally photographed, for delivery of heightened impact upon the members of said audiences, where the improvement comprises the use of computerized image-generating techniques to generate transitional images; such techniques evaluating the motion and appropriate location of each pixel of each of the images in the original film, and such transitional images being inserted between each of the original images of said motion picture to accurately depict the exact appearance that said previously-produced motion picture would have had if it had originally been photographed at the frame rate at which it is projected to said audiences.
